(19) United States
(12) Patent Application Publication
(10) Pub. No.: US 2013/0038983 A1
(43) Pub. Date: Feb. 14, 2013

(54) CONDUCTIVE PASTE FOR INTERNAL ELECTRODE OF MULTILAYER CERAMIC ELECTRONIC COMPONENT AND MULTILAYER CERAMIC ELECTRONIC COMPONENT USING THE SAME

(71) Applicants: Hyo Sub KIM, Suwon (KR); Jeong Ryeol KIM, Seongnam (KR); Sang Hoon KWON, Suwon (KR); Gun Woo KIM, Seoul (KR); Chang Hoon KIM, Yongin (KR)

(72) Inventors: Hyo Sub KIM, Suwon (KR); Jeong Ryeol KIM, Seongnam (KR); Sang Hoon KWON, Suwon (KR); Gun Woo KIM, Seoul (KR); Chang Hoon KIM, Yongin (KR)

(73) Assignee: SAMSUNG ELECTRO-MECHANICS CO., LTD.

(21) Appl. No.: 13/333,213

(22) Filed: Dec. 21, 2011

(30) Foreign Application Priority Data
Aug. 10, 2011 (KR) 10-2011-0079695

(51) Int. Cl. H01G 4/12; H01B 1/02; H01F 5/00; B82Y 99/00; B82Y 30/00

(52) U.S. Cl. 361/321.1; 252/512; 252/513; 252/514; 336/200; 977/777; 977/775; 977/948; 977/932

(57) ABSTRACT

There is provided a conductive paste for an internal electrode of a multilayer ceramic electronic component and a multilayer ceramic electronic component using the same. One or more nitride powders containing a nitride selected from the group consisting of silicon nitride, boron nitride, aluminum nitride, a vanadium nitride are added to the conductive paste for an internal electrode to increase a shrinkage initiation temperature of the internal electrodes. Accordingly, the reliability of the multilayer ceramic electronic component can be improved by using the conductive paste for an internal electrode.

### CROSS-REFERENCE TO RELATED APPLICATIONS

This application claims the priority of Korean Patent Application No. 10-2011-0079695 filed on Aug. 10, 2011, in the Korean Intellectual Property Office, the disclosure of which is incorporated herein by reference.

### BACKGROUND OF THE INVENTION

1. Field of the Invention

The present invention relates to a conductive paste for an internal electrode of a multilayer ceramic electronic component and a multilayer ceramic electronic component using the same and, more particularly, to a conductive paste for an internal electrode for manufacturing a reliable multilayer ceramic electronic component, and a multilayer ceramic electronic component using the same.

2. Description of the Related Art

As electronic devices have been rapidly reduced in size and have increasingly higher performances, a multilayer ceramic capacitor, a core passive component of electronic devices, has tended to have a high capacity while becoming thinner.

In general, in manufacturing of a multilayer ceramic electronic component, internal electrodes are printed on a ceramic dielectric sheet, ceramic dielectric sheets with the internal electrodes printed thereon are laminated, cut and fired to form chips, and then external electrodes are formed on individual chips.

In the case of a ceramic dielectric sheet having internal electrodes printed thereon, the printed internal electrodes may have a low sintering initiation temperature, such that the sintering thereof may be initiated at a temperature lower than that of the ceramic dielectric sheets.

As a result, the internal electrodes may be overly fired so as to cohere in a state in which metal components are non-uniformly distributed. After the firing operation, disconnected portions may be present in the internal electrodes, considerably degrading connectivity of the internal electrodes to thus degrade capacitance.

Also, respective shrinkage behaviors of the ceramic dielectric and the internal electrodes may be different, thereby causing internal deficiencies such as exfoliation, cracking, or the like, of the dielectric layer, when fired.

In order to eliminate these defects, attempts at adding barium titanate to a paste for an internal electrode or coating an oxide on a surface of nickel particles to increase the shrinkage initiation temperature of nickel when used as a main material in the internal electrodes have been undertaken.

However, when barium titanate is added to the paste for an internal electrode, the added barium titanate may infiltrate the dielectric layers in a sintering process to accelerate the growth of barium titanate particles existing in the dielectric layers, resulting in a degradation of a breakdown voltage (BDV).

In addition, when an oxide is coated on the surface of nickel, nickel may react negatively with the ceramic to bring about an effect of changing the characteristics of the ceramic, and when a coated layer is formed on or around nickel particles which have cohered, rather than having been completely dispersed, shrinkage of the nickel particles existing within the coated layer may be initiated at a low temperature as was originally the case (namely, according to their original characteristics). Then, the coated layer may be damaged, speeding up sintering, and the oxide may be extruded to the outside of the sintered body, resulting in a failure of exhibiting the effect of restraining the sintering of nickel.

### SUMMARY OF THE INVENTION

An aspect of the present invention provides a conductive paste for an internal electrode of a multilayer ceramic electronic component capable of allowing for the manufacturing of a reliable multilayer ceramic electronic component and a multilayer ceramic electronic component using the same.

According to an aspect of the present invention, there is provided a conductive paste for an internal electrode of a multilayer ceramic electronic component, including: a conductive metal powder and one or more nitride powders containing a nitride selected from the group consisting of silicon nitride, boron nitride, aluminum nitride, and vanadium nitride.

The content of the nitride powder may be 5 parts by weight to 20 parts by weight based on 100 parts by weight of the conductive metal powder.

A conductive metal for the conductive metal powder may be any one selected from the group consisting of nickel, palladium, copper, gold, silver, and an alloy thereof.

The average particle size of the conductive metal powder may range from 80 nm to 120 nm.

The average particle size of the nitride powder may range from 30 nm to 50 nm.

A shrinkage initiation temperature of the conductive paste for the internal electrode may be 700 └ or higher, and may be equal to or lower than a shrinkage initiation temperature of a ceramic dielectric.

According to another aspect of the present invention, there is provided a multilayer ceramic electronic component including: a ceramic main body; an external electrode formed on outer face of the ceramic main body; and an internal electrode formed within the ceramic main body, connected to the external electrode, and having a conductive metal and one or more nitrides selected from the group consisting of silicon nitride, boron nitride, aluminum nitride, and vanadium nitride.

The content of the nitride may be 5 parts by weight to 20 parts by weight based on 100 parts by weight of the conductive metal.

The conductive metal may be any one selected from the group consisting of nickel, palladium, copper, gold, silver, and an alloy thereof.

The average grain size of the conductive metal may range from 80 nm to 120 nm.

The average grain size of the nitride may range from 30 nm to 50 nm.

A shrinkage initiation temperature of the internal electrode may be 700 └ or higher, and may be equal to or lower than a shrinkage initiation temperature of a ceramic dielectric.

### BRIEF DESCRIPTION OF THE DRAWINGS

The above and other aspects, features and other advantages of the present invention will be more clearly understood from the following detailed description taken in conjunction with the accompanying drawings, in which:

FIG. 1(A) is a perspective view of a multilayer ceramic electronic component and FIG. 1(B) is a cross-sectional view taken along line A-A′ according to an embodiment of the present invention;

FIG. 2 is a graph showing the results of X-ray diffraction analysis of titanium nitride which underwent a phase stability experiment; and

FIG. 3 is a graph showing a sintering shrinkage behavior of a conductive paste for an internal electrode over the content of silicon nitride used in an embodiment of the present invention.

### DETAILED DESCRIPTION OF THE INVENTION

Embodiments of the present invention will now be described in detail with reference to the accompanying drawings. The invention may, however, be embodied in many different forms and should not be construed as being limited to the embodiments set forth herein.

Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

Multilayer ceramic electronic components may include a multilayer ceramic capacitor, a chip inductor, chip beads, and the like. Hereinafter, the present invention will be described in detail by taking the multilayer ceramic capacitor as an example.

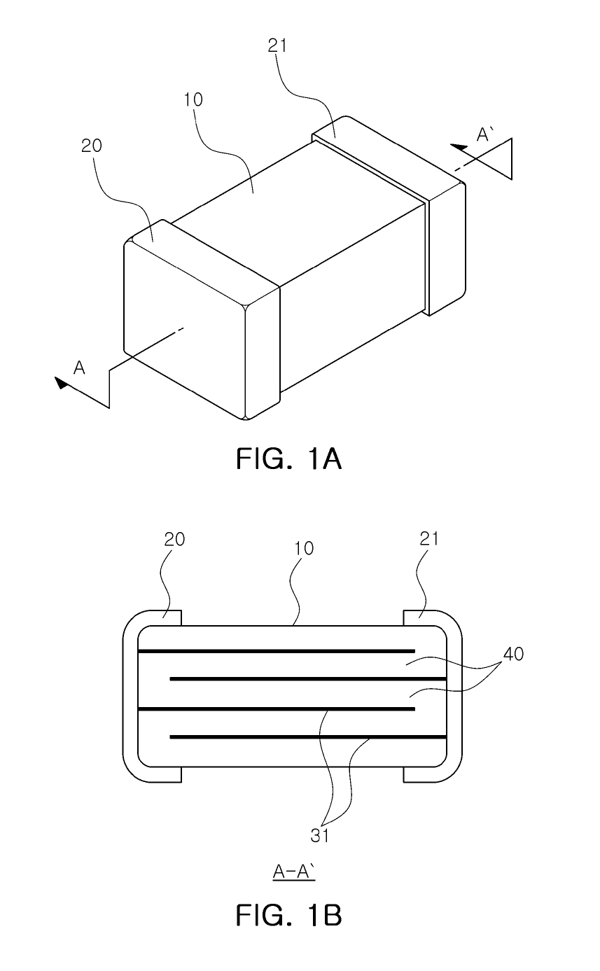

FIG. 1(A) is a perspective view of a multilayer ceramic electronic component and FIG. 1(B) is a cross-sectional view taken along line A-A′ according to an embodiment of the present invention.

With reference to FIG. 1, the multilayer ceramic capacitor (MLCC) may include a ceramic main body 10, external electrodes 20 and 21, and internal electrodes 31.

The ceramic main body 10 may be formed of a ceramic material having high permittivity, and a barium titanate (BaTiO₃)-based material, a lead-composite perovskite-based material, a strontium titanate (SrTiO₃)-based material, or the like, may be used as a material in the ceramic main body 10, but the present invention is not limited thereto.

The ceramic main body 10 may be formed by laminating a plurality of ceramic dielectric layers 40 and then sintering the same, and here, adjacent dielectric layers 40 may be integrated such that a boundary therebetween cannot readily be discerned.

The external electrodes 20 and 21 may be formed of a conductive metal. For example, the external electrodes 20 and 21 may be formed of copper, a copper alloy, nickel, a nickel alloy, silver, palladium, and an alloy thereof, or the like, but the present invention is not limited thereto.

The external electrodes 20 and 21 may be formed on both end surfaces of the capacitor main body. Here, the external electrodes 20 and 21 may be formed to be electrically connected to the internal electrodes 31 formed to be exposed from one face of the ceramic main body 10.

One end of each of the internal electrodes 31 may be exposed from one face of the ceramic main body 10. When one end of an internal electrode is formed to be exposed from one face of the ceramic main body 10, one end of an adjacent internal electrode may be formed to be exposed from the opposite face of the ceramic main body 10.

The internal electrode 31 may include a conductive metal and a nitride.

Nickel (Ni), a nickel alloy, or the like, may be used as the conductive metal, but the present invention is not limited thereto.

The average particle size of the conductive metal may range from 80 nm to 120 nm.

When the size of conductive metal particles is smaller than 80 nm, shrinkage in a sintering process may be difficult to control, while when the size of the conductive particles exceeds 120 nm, it may be difficult to form the internal electrodes as thin films.

The nitride may be one or more selected from the group consisting of silicon nitride (Si₃N₄), boron nitride (BN), aluminum nitride (AlN), and vanadium nitride (VN).

Nitrides are widely used for industrial purposes. Silicon nitride (Si₃N₄), titanium nitride (TiN), boron nitride (BN), vanadium nitride (VN), tantalum nitride (TaN), and the like, have high strength, so they may be used in tool steel or in a material for a ceramic structure, and gallium nitride (GaN), aluminum nitride (AlN), indium nitride (InN), and the like, are commonly used in an the field of electronic materials such as group III-V semiconductor light emitting devices, or the like.

Among the nitrides, silicon nitride (Si₃N₄), boron nitride (BN), aluminum nitride (AlN), vanadium nitride (VN), and the like, may be applied to internal electrodes for a multilayer ceramic electronic component. These elements may be selected through a phase stability evaluation, and phase stability experimentation may be conducted as follows.

Namely, among barium titanate and nitride candidate materials, test samples of silicon nitride, boron nitride, titanium nitride, aluminum nitride, gallium nitride, vanadium nitride, tantalum nitride, and the like, were placed in a tube furnace and a nitrogen gas was supplied thereto to thermally treat the samples at 600 └ for 36 hours. X-ray diffraction analysis was conducted on the respective nitride powders which underwent the thermal treatment to thus check whether or not each nitride was decomposed to form a new phase (by-product) to thus evaluate phase stability of the respective nitrides.

Table 1 below shows the results of the phase stability evaluation of the nitride candidate materials.

TABLE 1

| | | Whether or not | |
|---|---|---|---|
| | | decomposed | Whether or not |
| | | (600_, nitrogen | by-product was |
| Sample | Material | atmosphere) | formed |
| 1 | Silicon nitride | No | — |
| 2 | Boron nitride | No | — |
| 3 | Titanium nitride | Yes | Titanium oxide |
| 4 | Aluminum nitride | No | — |
| 5 | Gallium nitride | Yes | Gallium oxide |
| 6 | Vanadium nitride | No | — |
| 7 | Tantalum nitride | Yes | Tantalum oxide |

With reference to Table 1, sample 1 corresponds to silicon nitride, sample 2 corresponds to boron nitride, sample 4 corresponds to aluminum nitride, and sample 6 corresponds to vanadium nitride. These samples did not undergo any phase change under the foregoing experimental conditions, were not decomposed, and did not generate any by-products. Thus, it is confirmed that silicon nitride, boron nitride, aluminum nitride, and vanadium nitride are stable under the foregoing experimental conditions.

Sample 3 corresponds to titanium nitride. Titanium nitride was decomposed to generate a titanium oxide by-product. Sample 5 corresponds to gallium nitride. Gallium nitride was decomposed to generate a gallium oxide by-product. Sample 7 corresponds to tantalum nitride, which was decomposed to generate a tantalum oxide by-product.

Based on the results, it is noted that, among the nitride candidate materials, silicon nitride, boron nitride, aluminum nitride, and vanadium nitride were stable, without undergoing a phase change, even after the thermal treatment, while titanium nitride, gallium nitride, and tantalum nitride all underwent phase changes and generated oxides as by-products.

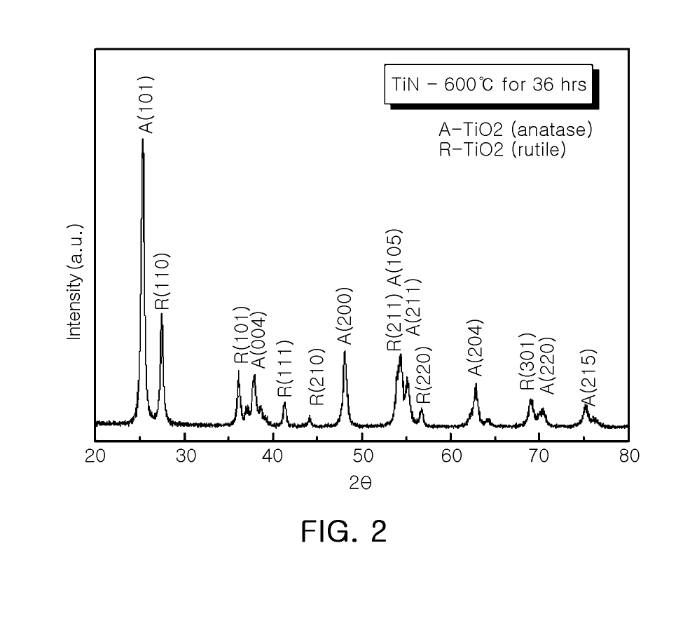

FIG. 2 shows the results of an X-ray diffraction analysis with respect to the titanium nitride which underwent the phase stability experiment. In particular, it is noted that, in the case of titanium nitride, decomposed titanium was reacted with a small amount of oxygen existing in the nitrogen atmosphere to form oxides having an anatase structure and a rutile structure.

The oxide generated as a by-product as the nitride is decomposed may be reacted with the dielectric layers when the ceramic lamination body is sintered, potentially changing the dielectric characteristics of the multilayer ceramic capacitor.

According to the results of the phase stability evaluation, it is noted that silicon nitride, boron nitride, aluminum nitride, and vanadium nitride, among the nitrides, are materials which are applicable to a ceramic electronic component.

By adding a nitride to the internal electrode paste, the shrinkage initiation temperature of the internal electrodes can be further increased.

The shrinkage initiation temperature may be defined as a temperature at which shrinkage of 5% takes place.

The nitride may be one or more selected from the group consisting of silicon nitride, boron nitride, aluminum nitride, and vanadium nitride. One type of nitride may be added to the internal electrode paste, or two or more types of nitrides may be mixed to be added to the internal electrode paste.

The increase in the shrinkage initiation temperature of the internal electrodes can be explained as follows.

Sintering may be undertaken in the following manner. Namely, a state in which powder particles are in contact may be considered an unstable state having a high energy state thermodynamically, because the size of the surface area of the particles is relatively large, on the whole. A tendency for powder particles to move toward a lower energy state when the surface area thereof is reduced, namely, a tendency in the case of a reduced surface area, may become a driving force that promotes sintering.

As temperature increases, the energy state of atoms existing within particles is gradually increased, and when a certain temperature is reached, the atoms existing in particles in contact with one another may move, to thereby allow the two particles to be merged.

When one or more nitride powders containing a nitride selected from the group consisting of silicon nitride, boron nitride, aluminum nitride, and vanadium nitride are added to the internal electrode paste, particles of the one or more nitride powders may be positioned between conductive particles such as nickel, or the like, reducing the probability that the conductive metal particles will be in contact with one another, to thus delay the sintering thereof.

During the sintering process, the nitride still exists as if it was a foreign object, and the growth of conductive metal particles can therefore be restrained.

The content of the nitride powder may be 5 to 20 parts by weight based on 100 parts by weight of the conductive metal powder.

In a case in which the content of the nitride powder is less than 5 parts by weight, the effect of increasing the shrinkage initiation temperature of the internal electrodes may be small, and when the content of the nitride powder exceeds 20 parts by weight, the volume of the silicon nitride may increase to degrade the connectivity of the internal electrodes, resulting in a degradation of the capacitance of the capacitor.

The nitride powder particles may not be particularly limited so long as they have a rounded shape. Namely, the nitride powder particles may have an ovoid shape or a spherical shape.

The average particle size of the nitride powder may range from 30 nm to 50 nm. When the size of the nitride powder particles is smaller than 30 nm, the effect of increasing the shrinkage initiation temperature would be small, and when the size of the nitride powder particles exceeds 50 nm, electrical characteristics of the internal electrodes would possibly be reduced.

The internal electrodes 31 may include a binder and a solvent in addition to the conductive metal powder particles and one or more nitride powders, selected from the group consisting of silicon nitride, boron nitride, aluminum nitride, and vanadium nitride.

The internal electrodes 31 may be formed by printing a paste for an internal electrode on a dielectric green sheet and firing the same. The internal electrodes 31 may be formed on the dielectric green sheet through a method such as screen printing, gravure printing, or the like.

As the binder, a polymer resin such as polyvinylbutyral, ethylcellulose, or the like, may be used.

The solvent of the conductive paste for an internal electrode is not particularly limited. For example, terpineol, dihydroterpineol, butylcarbitol, kerosene, or the like, may be used as the solvent.

A multilayer ceramic electronic component according to another embodiment of the present invention may include: a ceramic main body 10; external electrodes 20 and 21 formed on a outer face of the ceramic main body 10; and internal electrodes 31 formed within the ceramic main body, connected to the external electrodes, and having a conductive metal and one or more nitrides selected from the group consisting of silicon nitride, boron nitride, aluminum nitride, and vanadium nitride.

The internal electrodes may be formed of any one selected from the group consisting of nickel, palladium, copper, gold, silver, and an alloy thereof, and the average grain size thereof may range from 80 nm to 120 nm.

The content of the one or more nitrides selected from the group consisting of silicon nitride, boron nitride, aluminum nitride, and vanadium nitride may be 5 to 20 parts by weight based on 100 parts by weight of the conductive metal, and the size of the grains thereof may range from 30 nm to 50 nm.

A shrinkage initiation temperature of the internal electrodes may be 700 └ or higher, and may be equal to or lower than a shrinkage initiation temperature of ceramic main body.

Details of the ceramic main body, the external electrodes, the internal electrodes, the conductive metal, and the nitrides are the same as those described above.

### Example 1

The conductive paste for an internal electrode of a multilayer ceramic electronic component was manufactured in a following manner.

Nickel powder, having an average particle size of 120 nm and silicon nitride, boron nitride, aluminum nitride, and vanadium nitride powders, having an average particle size of 30 nm, were prepared, and the respective nitrides were weighed to be 0, 2.5, 5.0, 10.0, 20.0 parts by weight, based on 100 parts by weight of the nickel powder, and mixed.

An ethyl cellulose (EC)-based binder and terpineol were added to the mixture of nickel and nitride powders and dispersed by a 3-roll mill to manufacture a conductive paste for an internal electrode of the multilayer ceramic capacitor.

The multilayer ceramic capacitor was manufactured in the following manner.

Barium titanate-based ceramic powder, a polyvinylbutyral-based resin as a binder, and ethanol as a solvent were mixed and then wet-mixed and dispersed by using a method such as ball-milling, or the like, to manufacture a ceramic slurry.

The ceramic slurry was applied to a polymer film through a doctor blade method and then dried to manufacture a ceramic green sheet.

The conductive paste for an internal electrode of the ceramic capacitor was screen-printed onto the ceramic green sheet to form an internal electrode pattern, and ceramic green sheets with the internal electrode pattern printed thereon were laminated, compressed, and then cut to manufacture a green chip.

The green chip underwent a debinder process in which a heat treatment was performed under a nitrogen atmosphere at 250 └, and were then sintered at 100 └ to 1200 └ under a reductive atmosphere to manufacture a fired chip.

As the Comparative Example, the same ingredients as those of the Example were prepared, except that barium titanate powder having an average particle size of 30 nm was added instead of the nitrides.

A shrinkage initiation temperature of the internal electrode paste and connectivity of the internal electrodes according to the types and contents of the nitrides were measured and evaluated, and delamination of the multilayer ceramic capacitor and reactivity between the internal electrodes and the barium titanate of the ceramic layer were evaluated.

A shrinkage behavior of the paste for an internal electrode was measured as follows.

After the paste for an internal electrode was dried, the dried paste was molded into a pellet by using a metal mold, and then, its shrinkage behavior was measured under a reductive atmosphere by using thermal mechanical analysis (TMA).

The shrinkage initiation temperature may be defined as a temperature at which a shrinkage rate is 5%.

The shrinkage initiation temperature may be determined through the TMA.

Connectivity of the internal electrodes may be defined as a ratio of an ‘actual total length of electrodes’ to ‘an ideal total length of electrodes’, namely, as “electrode connectivity”=“actual total length of electrodes”/“total length of electrodes”.

The “ideal total length of electrodes” may be calculated by multiplying the length of a single internal electrode by the number of internal electrode lamination layers, and the “actual total length of electrodes” may be calculated as the length of the remaining portions of the electrodes, excluding portions where electrodes are disconnected.

In detail, based on a photographic image of a section perpendicular to the lamination direction of the internal electrodes taken by a microscope at a high level of magnification, the number of pixels may be counted, and the relative ratio of the number of pixels may be calculated to calculate the connectivity of the internal electrodes.

When the internal electrodes have high connectivity, it indicates that the internal electrodes are formed with little empty space therein, so that a relatively large capacitance can be secured, but when the internal electrodes have low connectivity, since the effective face forming capacitance is reduced, the relatively low connectivity may be inappropriate in forming capacitance.

Delamination refers to a phenomenon in which the internal electrodes and ceramic layers of the multilayer ceramic electronic component are separated. The occurrence of delamination may lead to a degradation of both electrical and mechanical characteristics of the multilayer ceramic electronic component.

Reactivity between the internal electrodes and the barium titanate of the ceramic layer refers to whether or not a material added to the internal electrodes reacts to barium titanate existing in the ceramic layer.

A reaction of the material added to the internal electrodes to barium titanate existing in the ceramic layer may result in a degradation of the performance of the multilayer ceramic electronic component.

Table 2 below shows the results of tests concerned with the shrinkage initiation temperature, the connectivity of internal electrodes, the occurrence of delamination in the multilayer ceramic electronic component, and reactivity between the internal electrodes and barium titanate of the ceramic layer according to the content of the respective nitrides.

TABLE 2

| | | Added | | | | Reactivity |
|---|---|---|---|---|---|---|
| | | amount | Shrinkage | Connectivity | | to barium |
| | | (Parts | initiation | of internal | Occurrence | titanate |
| | Added | by | temperature | electrodes | of | of ceramic |
| Sample | material | weight) | (—) | (%) | delamination | layer |
| 1* | Barium | 10 | 850 | 95.4 | NO | YES |
| | titanate | | | | | |
| 2 | Silicon | 5 | 780 | 95.2 | NO | NO |
| | nitride | | | | | |
| 3 | Silicon | 10 | 830 | 96.1 | NO | NO |
| | nitride | | | | | |
| 4 | Silicon | 20 | 835 | 92.3 | NO | NO |
| | nitride | | | | | |
| 5 | Aluminum | 5 | 790 | 91.4 | NO | NO |
| | nitride | | | | | |
| 6 | Aluminum | 10 | 810 | 92.6 | NO | NO |
| | nitride | | | | | |
| 7 | Boron | 5 | 850 | 93.2 | NO | NO |
| | nitride | | | | | |
| 8 | Boron | 10 | 864 | 94.5 | NO | NO |
| | nitride | | | | | |
| 9 | Vanadium | 10 | 700 | 94.2 | NO | NO |
| | nitride | | | | | |
| 10 | Vanadium | 20 | 845 | 90.1 | NO | NO |
| | nitride | | | | | |

*Indicates Comparative Example

With reference to Table 2, sample 1 corresponds to a case in which 10 parts by weight of barium titanate was added to the paste for an internal electrode. In this case, the shrinkage initiation temperature was 850 └, exceeding 700 └, the connectivity of the internal electrodes was 95.4%, exceeding 90%, and delamination did not occur. However, barium titanate added to the internal electrodes reacted to barium titanate existing in the ceramic layer.

Regarding the shrinkage initiation temperature, a temperature exceeding 700 └ was used as a reference shrinkage initiation temperature, and this temperature did not cause degradation in terms of reliability. Also, 90% or more of internal electrode connectivity was used as a reference connectivity, and this was aimed at securing appropriate capacitance.

Samples 2 to 4 correspond to cases in which 5 parts by weight, 10 parts by weight, and 20 parts by weight of silicon nitride were respectively added to the paste for an internal electrode. Their respective shrinkage initiation temperatures were 780 └, 830 └, and 835 └, all exceeding 700 └, and their levels of internal electrode connectivity were 95.2%, 96.1%, and 92.3%, respectively, all exceeding 90%, while delamination did not occur. Also, there was no reaction between silicon nitride added to the internal electrodes and barium titanate existing in the ceramic layer.

Samples 5 and 6 correspond to cases in which 5 parts by weight and 10 parts by weight of aluminum nitride were added to the paste for an internal electrode, respectively. Their shrinkage initiation temperatures were 790 └ and 810 └, respectively, exceeding 700 └, their levels of internal electrode connectivity were 91.4% and 92.6%, respectively, all exceeding 90%, while delamination did not occur. Also, there was no reaction between aluminum nitride added to the an internal electrodes and barium titanate existing in the ceramic layer.

Samples 7 and 8 correspond to cases in which 5 parts by weight and 10 parts by weight of boron nitride were added to the paste for an internal electrode, respectively. Their shrinkage initiation temperatures were 850 └ and 864 └, respectively, exceeding 700 └, their levels of internal electrode connectivity were 93.2% and 94.5%, respectively, all exceeding 90%, and delamination did not occur. Also, there was no reaction between boron nitride added to the an internal electrodes and barium titanate existing in the ceramic layer.

Samples 9 and 10 correspond to cases in which 10 parts by weight and 20 parts by weight of vanadium nitride were added to the paste for an internal electrode, respectively. Their shrinkage initiation temperatures were 700 └ and 845 └, respectively, exceeding 700 └, their levels of internal electrode connectivity were 94.2% and 90.1%, respectively, all exceeding 90%, and delamination did not occur. Also, there was no reaction between vanadium nitride added to the internal electrodes and barium titanate existing in the ceramic layer.

With reference to Table 2, it is noted that as the content of nitride is increased, the shrinkage initiation temperature of the paste for an internal electrode may be also increased.

The reason for which the shrinkage initiation temperature increased is as follows: As temperature increases, particles connected so as to reduce a specific surface area in the fine granular nickel powder are merged and grown, and here, when the nickel particles are grown, since the nitride exists between the nickel particles, the probability in which the nickel particles are in direct contact is reduced, which may be interpreted as resulting in the increase in the sintering initiation temperature.

Hereinafter, a sintering behavior of the internal electrodes according to the content of silicon nitride included in the internal electrodes will be described.

Table 3 below shows the shrinkage initiation temperature of the conductive paste for an internal electrode and connectivity of internal electrodes according to the content (0, 2.5, 5, 10, 20 parts by weight) of silicon nitride Si₃N₄ in the Example.

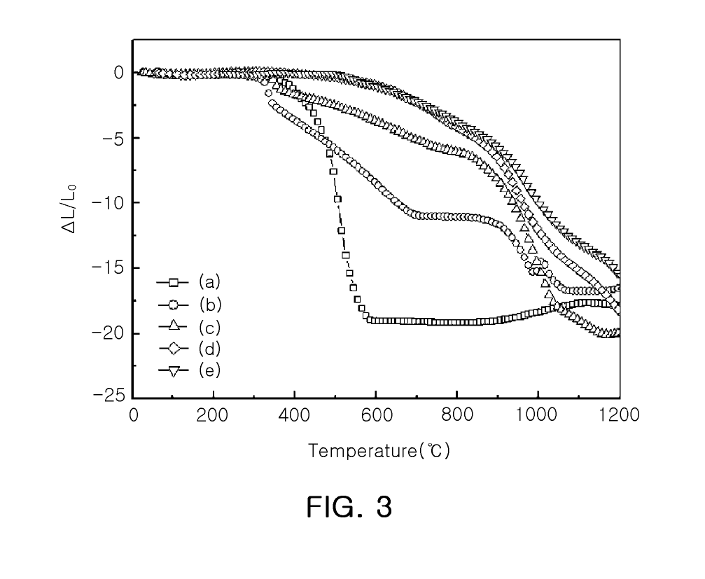

FIG. 3 shows a sintering shrinkage behavior of the conductive paste for an internal electrode according to the content (0, 2.5, 5, 10, 20 parts by weight) of silicon nitride Si₃N₄ in the Example.

TABLE 3

| | | Shrinkage | |
|---|---|---|---|
| | Content of | initiation | Connectivity of |
| | silicon | temperature | internal |
| Sample | nitride (%) | (L) | electrodes (%) |
| 1 | 0 | 500 | 64.5 |
| 2 | 2.5 | 500 | 85.2 |
| 3 | 5 | 780 | 95.2 |
| 4 | 10 | 830 | 96.1 |
| 5 | 20 | 835 | 92.3 |

With reference to Table 3, Sample 1 corresponds to a case (a) in which silicon nitride was not added to the conductive paste for an internal electrode and Sample 2 corresponds to a case (b) in which 2.5 parts by weight of silicon nitride was added to the conductive paste for internal electrode. In both cases, the shrinkage initiation temperature was 500 └, lower than 700 └, and the levels of connectivity of internal electrodes were 64.5% and 85.2%, respectively, all less than 90%.

It is confirmed that the addition of about 2.5 parts by weight of silicon nitride did not greatly affect the increase in the shrinkage initiation temperature.

When 5 parts by weight, 10 parts by weight, and 20 parts by weight of silicon nitride were added to the conductive paste for an internal electrode (c, d, and e), respectively, the shrinkage initiation temperatures were 780 └, 830 └, and 835 └, respectively, all exceeding 700 └, and the levels of connectivity of internal electrodes were 96.1% and 92.3%, respectively, all exceeding 90%.

Meanwhile, when the content of silicon nitride exceeds 20 parts by weight, since the volume of the silicon nitride is increased, the connectivity of the internal electrodes would possibly be degraded, possibly resulting in a degradation of capacitance of the capacitor.

With reference to FIG. 3, when the silicon nitride was not added to the conductive paste for an internal electrode (a), the curved line (graph) is rapidly reduced when passing the shrinkage initiation temperature, and thereafter, it tends to be almost uniformly maintained.

When the internal electrodes are rapidly shrunken, there is stress due to the difference in dimensions between the internal electrodes and the ceramic dielectric layers therein, which may possibly cause cracking or delamination. Even in the case that a crack or delamination does not occur, when an impact or heat is applied thereto in a follow-up mounting process, or the like, cracking, or the like, may be easily generated.

Meanwhile, when the silicon nitride is added (b, c, d, and e), the curved lines (graph) tend to be gradually reduced over the entire temperature range. This may be interpreted as a rapid shrinkage of the internal electrodes being restrained by virtue of the silicon nitride added to the internal electrodes.

Also, as the content of the silicon nitride is increased (b→c→d→e), the angle of the curved lines (graph) becomes gentler. This indicates that the sintering restraining effect by the silicon nitride is increased as the content of the silicon nitride is increased.

As set forth above, according to embodiments of the invention, in the multilayer ceramic electronic component manufactured by using the conductive paste for internal electrode, the shrinkage initiation temperature of the internal electrodes is increased to a relatively high temperature, thereby improving the difference in stress caused by the difference in thermal expansion between the ceramic dielectric sheet and the internal electrodes, improving the cohesion phenomenon of the internal electrodes and connectivity of the internal electrodes, improving delamination of the multilayer ceramic electronic component, and improving the reliability of the multilayer ceramic electronic component.

While the present invention has been shown and described in connection with the embodiments, it will be apparent to those skilled in the art that modifications and variations can be made without departing from the spirit and scope of the invention as defined by the appended claims.

What is claimed is:

1. A conductive paste for an internal electrode of a multilayer ceramic electronic component, the paste comprising:
a conductive metal powder; and
one or more nitride powders containing a nitride selected from the group consisting of silicon nitride, boron nitride, aluminum nitride, and vanadium nitride.

2. The conductive paste of claim 1, wherein the content of the nitride powder is 5 parts by weight to 20 parts by weight based on 100 parts by weight of the conductive metal powder.

3. The conductive paste of claim 1, wherein a conductive metal for the conductive metal powder is any one selected from the group consisting of nickel, palladium, copper, gold, silver, and an alloy thereof.

4. The conductive paste of claim 1, wherein the average particle size of the conductive metal powder ranges from 80 nm to 120 nm.

5. The conductive paste of claim 1, wherein the average particle size of the nitride powder ranges from 30 nm to 50 nm.

6. The conductive paste of claim 1, wherein a shrinkage initiation temperature of the conductive paste for the internal electrode is 700 └ or higher, and is equal to or lower than a shrinkage initiation temperature of a ceramic dielectric.

7. A multilayer ceramic electronic component comprising:
a ceramic main body;
an external electrode formed on outer face of the ceramic main body; and
an internal electrode formed within the ceramic main body, connected to the external electrode, and having a conductive metal and one or more nitrides selected from the group consisting of silicon nitride, boron nitride, aluminum nitride, and vanadium nitride.

8. The multilayer ceramic electronic component of claim 7, wherein the content of the nitride is 5 parts by weight to 20 parts by weight based on 100 parts by weight of the conductive metal.

9. The multilayer ceramic electronic component of claim 7, wherein the conductive metal is any one selected from the group consisting of nickel, palladium, copper, gold, silver, and an alloy thereof.

10. The multilayer ceramic electronic component of claim 7, wherein the average grain size of the conductive metal ranges from 80 nm to 120 nm.

11. The multilayer ceramic electronic component of claim 7, wherein average grain size of the nitride ranges from 30 nm to 50 nm.

12. The multilayer ceramic electronic component of claim 7, wherein a shrinkage initiation temperature of the internal electrode is 700 └ or higher, and is equal to or lower than a shrinkage initiation temperature of a ceramic dielectric.
